(19) United States
(12) Patent Application Publication
(10) Pub. No.: US 2005/0173369 A1
(43) Pub. Date: Aug. 11, 2005

(54) Beverage container with a packet containing green tea or other nutritional supplements

(76) Inventor: Takeshige Yokota, Gardena, CA (US)

Correspondence Address: Pitney, Hardin, Kipp & Szuch, 685 Third Avenue, New York, NY, 10017, US

(21) Appl. No.: 10/772,922

(22) Filed: Feb. 5, 2004

(51) Int. Cl. C12C 1/027

(52) U.S. Cl. 215/263; 426/106

(57) ABSTRACT

A beverage container with a packet containing green tea or other nutritional supplements is disclosed. A preferred version of the packet is a leaf shaped device which attaches to the beverage container around the neck thereof, especially a beverage bottle made of glass or plastic containing any beverage drink for consumption by individuals. The packet may be a vacuum packed container made out of aluminum to act as a vessel which will contain green tea (such as green tea powder, black tea powder, oolong tea powder, white tea powder, jasmine tea powder) or a nutritional powder supplement which can be added to the bottle contents just prior to consumption to maintain freshness.

### BACKGROUND

This invention relates to beverage containers with packets containing green tea or other nutritional supplements. More particularly, this invention relates to a leaf shaped device which attaches to a beverage container around the neck of the bottle, specifically a beverage bottle made out of glass or plastic containing any beverage drink for individual consumption.

Tea has been enjoyed all over the world for ages. Japan and Europe have been particular connoisseurs of green tea. The United States has seen an increased popularity of green tea consumption, but has not developed a distinguishing taste for green tea because of the poor quality of tea leaves used here. In addition, the traditional methods of brewing green tea requires a large amount of time (over ten minutes) and produces a weak and flavorless tea. These factors have kept the market for prepared green tea-beverages-products relatively small in the United States.

In recent years, the health benefits of green tea has been studied and shown to be very favorable. It has been found that green tea leaves contain tannin, caffeine, theanine, vitamin A, C and E, dietary fiber, chlorophyll, minerals among other things. The benefits of these ingredients are many including cell oxidation, decreased blood pressure, stimulation of the circulatory system, and normalization of blood fat to name a few. (Green Tea, 1998 Taylor, N. M.S., R.D.)

### SUMMARY

The present invention is directed to a beverage container with a packet containing green tea or other nutritional supplements that satisfies this need. In a preferred version of the present invention, a packet is a leaf shaped device which attaches to a beverage container around the neck of the bottle, especially a beverage bottle made of glass or plastic containing any beverage drink for consumption by individuals. A preferred version of the above mentioned device will be a vacuum packed container made out of aluminum to act as a vessel which will contain green tea (such as green tea powder, black tea powder, oolong tea powder, white tea powder, jasmine tea powder) or a nutritional powder supplement which can be added to the bottle contents just prior to consumption to maintain freshness.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a beverage container of glass material with a green tea packet attached to a neck of the container according to a version of the present invention;

FIG. 2 is a perspective view of a beverage container of plastic bottle material with a green tea packet attached to a neck of the container according to an another version of the present invention;

FIG. 3 is an enlarged plane view of a preferred form of the packet as shown in FIG. 1 or FIG. 2;

FIGS. 4 and 5 are plane views of different forms of the packet as shown in FIG. 1 or FIG. 2; and

FIG. 6 is a plane view of a modified form of the packet as shown in FIG. 1 or FIG. 2.

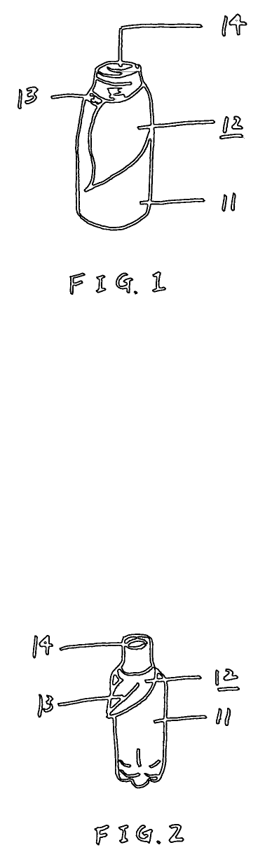

### DETAILED DESCRIPTION OF THE INVENTION

The present invention provides for a method for attaching nutritional supplements in powdered form to individual beverage containers. The method comprises a leaf shaped packet made out of aluminum which extends from a circular shaped ring that can be placed directly on the neck of the bottle as the last stage of the bottling process just prior to the last step of placing a cap on the bottle. The leaf shaped packet will be made available in a variety of sizes, containing anywhere from 1 gram to 8 grams of any powdered nutritional substance, including powered green tea, black tea, white tea, jasmine tea, and oolong tea. The size of the ring that allows the leaf to be attached to the bottle will be made in a variety of sizes to accommodate all standard bottles for use in individual consumption.

The package will be manufactured in such a way to allow for full disclosure of all contents inside the leaf shaped packet and will contain design features which resemble all natural characteristics of a natural leaf. The device will be made to insure that it will be able to remain attached to the bottle during distribution of the product but will contain a ready to use feature which will allow consumers ease of use in abstracting the contents of the devise for consumption.

The device will be made specifically for powdered tea supplements and any other nutritional supplements made for consumer beverages, such as protein supplements, and all matter of vitamin and protein supplements.

It should be understood that the consumer can mix the contents of the above mentioned device into any liquid beverage. The contents of the device may consist of any powdered nutritional supplement. The device with nutritional supplements will be sold directly to beverage manufacturers such as the makers of Snapple™ Brand fruit drinks. Beverage manufacturers will attach the device to the individual bottle during the bottling process, just prior to the final step of placing the cap on the bottle to seal the contents and prepare the bottle for safe distribution and handling prior to consumption.

The shape of the device will be a circular ring designed to fit securely under the cap of the bottle resting just on top of the bottle neck. Extending from the circular ring will be a leaf shaped vacuum air packed aluminum foil packet that will contain a single nutritional supplement, such as vitamin or protein supplements or an organic food supplement with nutritional ingredients such as green tea, or other powdered nutritional supplements appropriate for use in fruit or other beverages.

Referring now to the drawings, there are illustrated several versions of a packet for beverage containers embodying the present invention. FIG. 1 shows beverage container with a packet according to a preferred version of the present invention. The container 11 is made of glass or plastic or other appropriate material for retaining liquid beverage. A leaf shaped packet 12 is made of aluminum with a circular shaped ring 13 at its upper portion that can be placed directly on the neck of the container 11 just before the last step of placing a cap 14 on the container 11. The leaf shaped packet 12 is adapted and designed to contain 1 gram to 8 grams of any powdered green tea or any other nutritional substance. The contents of the leaf shaped packet 12 may be powdered green tea, black tea, white tea, jasmine tea or oolong tea or any other nutritional supplements such as protein supplements and vitamin supplements or mixed supplements. As seen from the drawings, the beverage container 11 is a plastic bottle 11 with a leaf shaped packet 12 as with the beverage glass container 11 of FIG. 1.

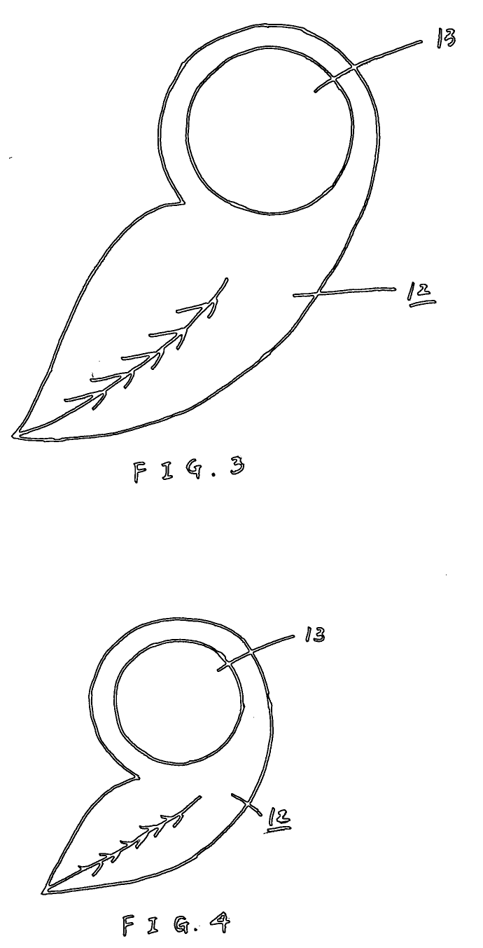

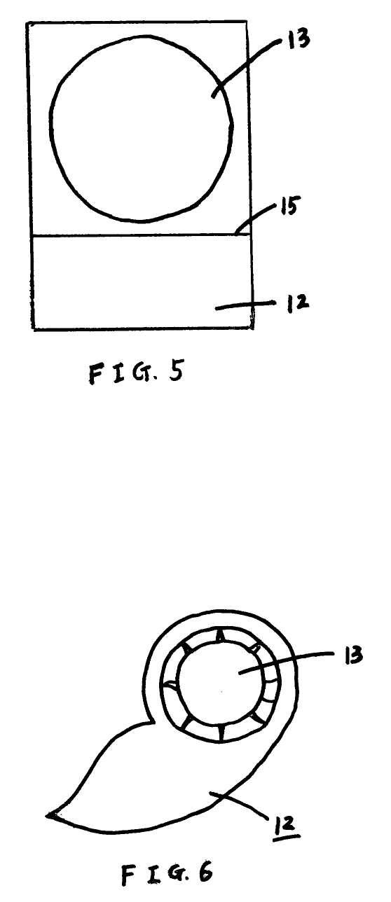

FIG. 3 is an enlarged plane view of the leaf shaped packet 12 which also contains the circular shaped ring 13 at its upper portion to be fit directly on the neck of the container 11 just before the last step of placing the cap 14 on the container 11. A lower portion of the leaf shaped packet 12 is a vacuum air packed cavity shaped to contain powdered green tea or any other nutritional supplements. FIG. 4 shows a different shape of the leaf shaped packet 12 with a design to allow easy disposal of powdered green tea or any other nutritional supplements. FIG. 5 shows a rectangular shaped packet 12 with the same circular shaped ring 13. A lower portion of the rectangular shaped packet 12 has a vacuum air packed cavity with a cutting line 15 for easy removal thereof.

FIG. 6 shows a modified version of a packet 12 having a serrated edge portion 16 which allows ease of placement over the bottle cap during the bottling process but prevents the device from falling off during the handling in the distribution process. In particular, the modified version of FIG. 6 allows placement of the packet 12 even after the bottling process is completed.

The present invention increases the amount of beneficial nutrients ingested, thus increasing the overall benefits of green tea consumption. The present invention provides consumers with the benefits of being able to avoid artificial preservatives while having a method for maximizing the nutritional and taste benefits from a vacuum packed, ready to use packet of freshly milled green tea in powder form, attached directly on an individual serving size bottle of any liquid beverage sold in retail locations.

The present invention provides the consumer with a convenient way to enjoy freshly milled green tea powder or other nutritional supplements, through the provision of a single use, vacuum packed and sealed package securely attached to an individual serving bottle, that offers superior taste, and nutritional value to industrial processed alternatives.

It is preferable that the present invention is based on a green tea leaf shaped packet design, which represents the benefits of nutrition, freshness, and quality from the powdered nutritional green tea supplement contents. However, while the invention herein has been described with reference to a tea leaf shaped package design with powdered green tea contents, it will be understood that various modifications to the package design and contents may be made to adapt the package design and contents to various beverage maker requirements in order to accommodate specific manufacturer requirements relating to ease of distribution and content preferences.

1. A beverage container with a packet device for containing powdered tea or other nutritional substances, the packet device being adapted to be attached to the beverage container at the neck thereof which consumers can use as an additive to their purchased beverage in order to maximize freshness, taste, and nutritional value of the enclosed powdered tea or nutrition supplement.

2. The beverage container of claim 1 wherein the packet device is prepared to contain a minimum of 1 gram to a maximum of 8 grams of powdered tea or other nutritional supplement.

3. The beverage container of claim 1 wherein the packet device is made in the shape of a leaf to imitate the natural characteristics of a leaf.

4. The beverage container of claim 1 wherein the packet device is made out of aluminum to guarantee freshness of the enclosed powdered tea or nutrition supplement.

5. A packet device for use with a beverage container for containing powdered tea or other nutritional substances, the packet device being adapted to be attached to the beverage container at the neck thereof which consumers can use as an additive to their purchased beverage in order to maximize freshness, taste, and nutritional value of the enclosed powdered tea or nutrition supplement.
